(19) United States
(12) Patent Application Publication
(10) Pub. No.: US 2011/0034313 A1
(43) Pub. Date: Feb. 10, 2011

(54) CENTRIFUGE WITH HYDRAULIC DRIVE UNIT

(75) Inventor: James J. HANKEY, Norwood, MA (US)

Correspondence Address: NIXON & VANDERHYE, PC, 901 NORTH GLEBE ROAD, 11TH FLOOR, ARLINGTON, VA, 22203, US

(73) Assignee: ANDRITZ SEPARATION INC., Arlington, TX (US)

(21) Appl. No.: 12/832,253

(22) Filed: Jul. 8, 2010

Related U.S. Application Data
(60) Provisional application No. 61/231,732, filed on Aug. 6, 2009.

(51) Int. Cl. B04B 9/06; B04B 9/08

(52) U.S. Cl. 494/83; 494/84

(57) ABSTRACT

A centrifuge includes a bowl. The bowl includes a cylindrical portion at a first end. The centrifuge further includes a hollow shaft. The hollow shaft is coaxial with the cylindrical portion and extends through at least the first end. The centrifuge also includes a hydraulic drive unit coupled to the cylindrical portion and configured to rotate the cylindrical portion. The hollow shaft and the cylindrical portion are rotatably coupled to each other.

### CROSS-REFERENCE TO RELATED APPLICATION

This application claims the benefit of U.S. Application 61/231,732, filed Aug. 6, 2009, the entire contents of which is incorporated herein by reference.

### FIELD OF THE INVENTION

The present invention relates to a direct drive of a decanter centrifuge with a hydraulic drive unit.

### BACKGROUND OF THE INVENTION

Decanter centrifuges typically employ a drive comprised of a belt to transmit power from a power source, such as an electric motor or hydraulic motor, to the centrifuge bowl. The power source is placed adjacent to the centrifuge to allow process material to be introduced into the centrifuge bowl at one end while a differential speed device is held or driven at the other end. The power source and differential speed device may be alongside, above or below the centrifuge. The power source and differential speed device may also be at the same end of the centrifuge.

### SUMMARY OF THE INVENTION

According to a sample embodiment, a centrifuge comprises a bowl. The bowl comprises a cylindrical portion at a first end. The centrifuge further comprises a hollow shaft. The hollow shaft is coaxial with the cylindrical portion and extends through at least the first end. The centrifuge also comprises a hydraulic drive unit coupled to the cylindrical portion and configured to rotate the cylindrical portion. The hollow shaft and the cylindrical portion are rotatably coupled to each other.

### BRIEF DESCRIPTION OF THE DRAWING

FIG. 1 schematically illustrates a centrifuge with a hydraulic drive unit according to a sample embodiment.

### DETAILED DESCRIPTION OF THE INVENTION

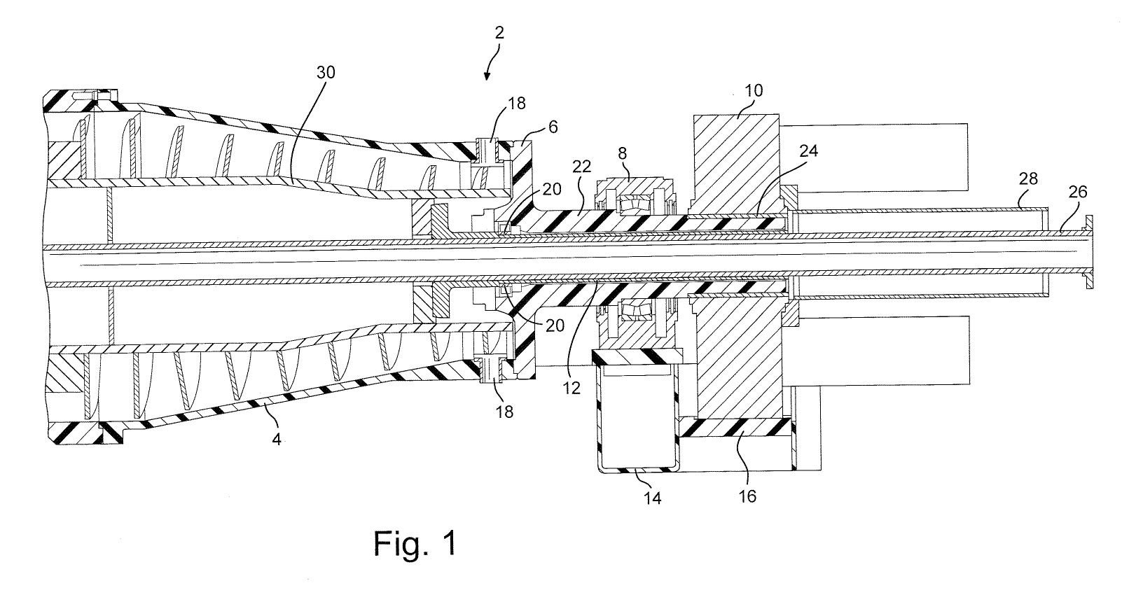

Referring to FIG. 1, a decanter centrifuge 2 comprises a bowl 4. The bowl 4 may have a frusto-conical shape. It should be appreciated that the bowl 4 may have another shape, for example, a portion of the bowl 4 may be cylindrical. A bowl head, or end member, 6 is attached to the bowl 4 and supported by a bearing assembly 8. The bearing assembly 8 is supported by a bearing pedestal 14. A plurality of outlets, or ports, 18 may be provided in the bowl 4 adjacent to the bowl end member 6.

The bowl end member 6 includes a cylindrical portion 22 that is supported by the bearing assembly 8. A hollow shaft 12 is provided coaxial with the cylindrical portion 22 of the bowl end member 6. The hollow shaft 12 extends through the cylindrical portion 22 and is connected to a scroll 30. The hollow shaft 12 is coupled to the bowl end member 6 by a bearing 20.

A hydraulic drive unit 10 is supported by a drive unit pedestal 16 and is coupled to the cylindrical portion 22 to rotate the bowl 4 through a coupling, or spline, 24 and the bowl end member 6. The hollow shaft 12 allows feed to be introduced through a feed pipe 26 in a conventional manner if connected to the feed end, or allows a differential speed device to be held or driven if connected to the other end of the centrifuge 2. The feed pipe 26 may be supported by a feed pipe support 28.

The hydraulic drive unit 10 may comprise a series of motors driving a torque combiner or a single motor. The hydraulic drive unit 10 may also comprise a hydrostatic transmission to drive the bowl 4.

The hydraulic drive unit 10 may provide a wide range of power and speed. The hydraulic drive unit 10 also eliminates drive belts that may become unreliable, for example due to overhung load, and difficult tensioning, particularly at high power. The hydraulic drive unit 10 may also be modified to include a hydraulic scroll drive.

The use of the hydraulic drive unit 10 also provides a soft start to the centrifuge 2. The hydraulic drive unit 10 also provides for variable speed capability and dynamic breaking. The use of the hydraulic drive unit 10 also allows the centrifuge 2 to be used in remote areas where three phase electrical power is not economical or available.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A centrifuge, comprising:
a bowl, the bowl comprising a cylindrical portion at a first end;
a hollow shaft, the hollow shaft being coaxial with the cylindrical portion and extending through at least the first end; and
a hydraulic drive unit coupled to the cylindrical portion and configured to rotate the cylindrical portion, wherein the hollow shaft and the cylindrical portion are rotatably coupled to each other.

2. A centrifuge according to claim 1, wherein the hollow shaft and the cylindrical portion are coupled by a bearing.

3. A centrifuge according to claim 1, wherein the cylindrical portion and the hydraulic drive unit are coupled by a coupling.

4. A centrifuge according to claim 1, wherein the cylindrical portion and the hydraulic drive unit are coupled by a spline.

5. A centrifuge according to claim 1, wherein the bowl comprises a frusto-conical section.

6. A centrifuge according to claim 1, wherein the bowl comprises only the cylindrical portion.

7. A centrifuge according to claim 1, wherein the cylindrical portion extends from a bowl end member.

8. A centrifuge according to claim 7, wherein the bowl end member is connected to the frusto-conical section.

9. A centrifuge according to claim 1, wherein the bowl comprises at least one port.

10. A centrifuge according to claim 9, wherein the at least one port is adjacent the bowl end member.

11. A centrifuge according to claim 1, wherein the hydraulic drive unit comprises at least one hydraulic motor.

12. A centrifuge according to claim 1, wherein the hydraulic drive unit comprises a series of hydraulic motors and a torque combiner driven by the series of hydraulic motors.

13. A centrifuge according to claim 1, wherein the hydraulic drive unit comprises a variable speed hydraulic drive unit.

14. A centrifuge according to claim 1, wherein the hydraulic unit comprises a fixed speed hydraulic drive unit.

15. A centrifuge according to claim 1, further comprising a scroll between the bowl and the hollow shaft.

16. A centrifuge according to claim 15, wherein the scroll comprises a frusto-conical portion.

17. A centrifuge according to claim 15, wherein the scroll is connected to the hollow shaft.

18. A centrifuge according to claim 15, wherein the hydraulic drive unit comprises a hydraulic scroll drive.

19. A centrifuge according to claim 1, further comprising a feed pipe co-axial with the hollow shaft.

20. A centrifuge according to claim 19, wherein a first end of the feed pipe is supported by, or adjacent to, the hydraulic drive unit.
